(19) United States
(12) Patent Application Publication
(10) Pub. No.: US 2019/0043002 A1
(43) Pub. Date: Feb. 7, 2019

(54) Fitting Room Management and Occupancy Monitoring System

(71) Applicants: Greg King, San DIego, CA (US); Bill Kepner, San Diego, CA (US); Steve Deal, San Diego, CA (US); Joe Budano, San Diego, CA (US); Derek Morikawa, San Diego, CA (US)

(72) Inventors: Greg King, San DIego, CA (US); Bill Kepner, San Diego, CA (US); Steve Deal, San Diego, CA (US); Joe Budano, San Diego, CA (US); Derek Morikawa, San Diego, CA (US)

(21) Appl. No.: 15/330,636

(22) PCT Filed: Apr. 16, 2015
(86) PCT No.: PCT/US2015/026223

§ 371 Date: Oct. 21, 2016

Related U.S. Application Data
(60) Provisional application No. 61/980,405, filed on Apr. 16, 2014.

(51) Int. Cl. G06Q 10/08; G06Q 30/02; G06K 9/00; G07C 9/00; G06F 9/54

(52) U.S. Cl. CPC G06Q 10/087; G06Q 30/02; G06F 9/541; G06K 9/00771; G07C 9/00174; G06K 9/00369

(57) ABSTRACT

Fitting room management and occupancy monitoring system for retail operations having fitting rooms wherein the system if capable of notifying staff of fitting room occupancy, the need for cleaning, and/or the need for customer help in real time as well as collecting and tracking data of fitting room activity according to preset business rules. The system further assists retail operations with reduction of theft incidents, improvement of conversion rates and employee compliance rates.

### RELATED APPLICATIONS

This application is a national stage application which claims the benefit of priority from International Patent Application No. PCT/US15/26223 filed Apr. 16, 2015, which claims the benefit of priority from U.S. Provisional Patent Application No. 61/980,405 filed on Apr. 16, 2014, the disclosure of which is hereby incorporated by reference in its entirety.

### FIELD OF THE INVENTION

The present invention pertains generally to retail store fitting rooms. More particularly, the present invention pertains to a monitoring and managing system for retail store operators with fitting rooms in their stores to reduce theft, build sales and increase staff productivity.

### BACKGROUND OF THE ART

Retailers suffer enormous loss of merchandise when thieves exploit the privacy of fitting rooms to remove alarm tags and other theft-deterrent mechanisms and then conceal merchandise when exiting the store (such as wearing layers of clothing, placing items in handbags, etc.). These losses extend beyond clothing as other merchandise is often concealed when entering a fitting room (typically by hiding the item(s) under a layer of clothing, a technique known as “draping”). Following theft incidents, fitting rooms are often littered with stripped tags (such as Electronic Article Surveillance (EAS) and denial-of-service devices) and other debris which may be encountered by the next customer.

While most retailers strive for periodic fitting room inspections by store staff (“staff”), compliance at store level is often unpredictable and unknown. The paper logs certifying inspections are easily forged at the end of a shift and have no visibility beyond the store, making compliance verification almost impossible. Even high compliance under this “inspect every 30 minutes” approach is wasteful since this often means expending labor hours to inspect fitting rooms that have not even been used. More than likely, though, inspections simply don't happen and customers are encountering untidy and uninviting fitting rooms. Worse yet, the theft residuals left in fitting rooms often promote additional theft since the environment suggests lax enforcement and the opportunity to intermingle evidence.

Retailers typically combat fitting room theft by locking the fitting rooms, requiring store staff to unlock the door so nobody sneaks in unnoticed, or with a heavy labor investment by assigning staff to the fitting room area full time to monitor clothing taken into and out of fitting rooms.

Although fitting rooms represent a critical step in the buying process for most apparel items, retail management remains largely unaware of fitting room traffic and other usage data that could empower them to adjust staffing, fitting room quality, and processes that could significantly increase profitability.

Systems for monitoring fitting rooms are known in the art. For example, U.S. Pat. No. 6,525,663 issued to Colmenarez et al. proposed an alarm system that monitors the entry and exit of a fitting room using image analysis, analysis of audio signatures of footfalls and other criteria to attempt to match the images of customers leaving the fitting room with stored images of customers entering the fitting room. If no match can be found, an alarm signal is generated.

Some additional solutions in the prior art for fitting room monitoring include the following examples:

“Sense System” by Alert Technologies combines a shopper help button with a button used by store staff to register fitting room occupancy to provide a local indication of fitting room status, i.e. occupied or unoccupied and management reports of occupancy activity, and to set a delayed notification to follow up with the customer.

Electronic Fitting Room Monitoring by WZ Technologies monitors garment activity into and out of fitting rooms, provides a help button for shoppers to request assistance from fitting rooms and monitors fitting room occupancy.

Fitting Room Assistance Network by Barcoding Inc. provides a system in which a PDA is used by store staff to assign a customer to a fitting room and scan garments being taken into the fitting room. In-room touchscreens allow customers to communicate with staff to request assistance and/or additional items.

Fitting Room Central analyzes the merchandise taken into a fitting room by a customer and compares it to the items purchased by the customer in order to generate customer inspired outfits which a sales associate may then suggest the customer consider purchasing.

There remains the need for a system capable of not only monitoring fitting room occupancy and capturing data associated with fitting room occupancy but also to provide intelligent notifications based on various business rules and user customized analysis that enhance loss prevention, improve retail operations, improve customer service, build retail sales, and generate market research.

In light of the above, it is an object of the present invention to provide the desired features described herein as well as additional advantages of providing fitting room usage data that could empower retail stores to adjust staffing, fitting room quantity, and processes that could increase profitability.

### SUMMARY OF THE INVENTION

The present invention is a fitting room occupancy monitoring and management system. The system is capable of monitoring and managing the status of a plurality of fitting rooms in one or more fitting room areas within a retail setting. The system provides store staff members with notification of when fitting rooms become occupied thereby heightening staff awareness of traffic and/or activity in the fitting room area. The system further provides automatic notification to staff members based on elapsed occupancy time to promote proactive customer engagement (termed “Proactive Touch”). The system also provides an in-room occupancy sound in the form of a chime or voice message along with a small flashing light, both of which are proven theft deterrents. The system provides an external indication of fitting room occupancy which aids customers in determining which fitting rooms are available for use.

The system also provides notifications to staff communication devices corresponding to fitting room vacancy and/or based on other business rules and inputs, such as intelligent inspection and unsold clothing re-stock task intervals. The system further provides adaptive occupancy/vacancy notifications to staff as a means of balancing awareness of activity in fitting rooms with notification overload. The system may further provide an efficient means to log time-stamped inspection results at each fitting room. The system further provides rapid notification to staff and management of detected theft events and monitoring devices such as video surveillance systems.

The system reduces fitting room theft through increased staff awareness of fitting room occupancy and subsequent vacancy after use. Staff awareness of fitting room activity promotes rapid detection of theft incidents. The system further provides management with awareness of timely inspection compliance that promotes clean and tidy fitting rooms and also promotes rapid detection of theft incidents. The system may further reduce fitting room theft by identifying fitting rooms with the highest theft rate so corrective action may be taken as well as the time of day when patterns of theft occur or increase so corrective action may be taken. Incorporation of an optional Fitting Room Lock feature limits unnecessary and undesirable access to fitting rooms thereby further reducing theft.

The system increases merchandise sales by increasing conversion rates, increasing ticket sales and building customer loyalty. Awareness of fitting room occupancy empowers a small store staff to provide customer assistance in an effective and efficient manner. The system further provides data analysis that identifies the best use of fitting room space v. sales space; the objective being to have sufficient fitting rooms to avoid abandonment that occurs when no room is available when needed while not using additional space that could be devoted to sales space for fitting rooms that are rarely used. Shopper loyalty and merchandise sales increase as a result of compliant inspections which keep fitting rooms clean and tidy.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates the system as initiated by a shopper interacting with a fitting room.

FIG. 2 illustrates the typical basic information flow among system and related components in one embodiment of the system.

FIG. 3 illustrates a sample displays for the fitting room management interface in one embodiment of the system.

FIG. 4 illustrates sample reports created by data collected in one embodiment of the system.

FIG. 5 illustrates fitting room icon concepts for the system.

FIG. 6 illustrates sweep compliance score elements for the system.

FIG. 7 illustrates the fitting room automated door lock for the system.

FIG. 8 illustrates a flow chart of the system level information and action processing for the system.

### DETAILED DESCRIPTION OF THE INVENTION

### Definitions:

“Notification” as used in the present invention may be any communication to store staff via any communication device or channel, including but not limited to, overhead PA speakers, two-way radios, wired or wireless telephones, smart wireless devices or pagers. Notification may also include display of fitting room status on a touchscreen, computer screen or mobile device.

“Confirmation action” as used in the present invention may be any act of a store staff member in response to a notification. Confirmation actions may be performed through any means by providing a communication path between the staff member and the system of the present invention, including but not limited to, buttons on the invention itself, a dedicated touchscreen in the fitting room area, or an application on a mobile device which may involve user interaction with a screen and/or barcodes, NFC tags, RFID, Bluetooth/BLE, or location determination devices or services.

### Operating Sequence:

The following description is a typical operating sequence of the system provided as an example of the functionality of the invention and is in no way meant to limit the scope of the invention and/or its capabilities. The operating variables permit the elimination and modification of operating steps based on user preference and potential situations.

### Shopper Enters Fitting Room:

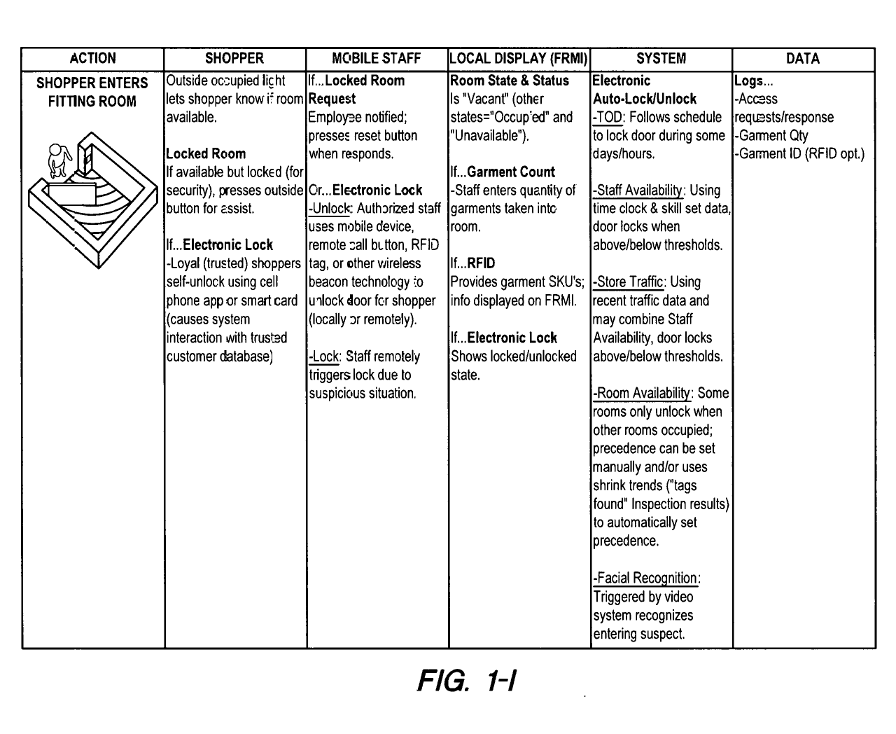

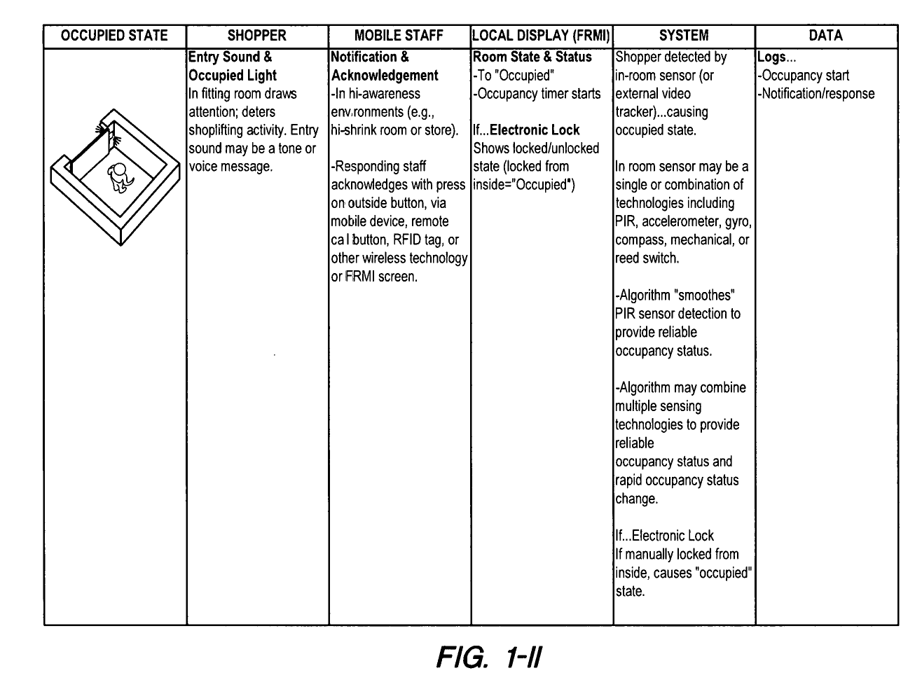

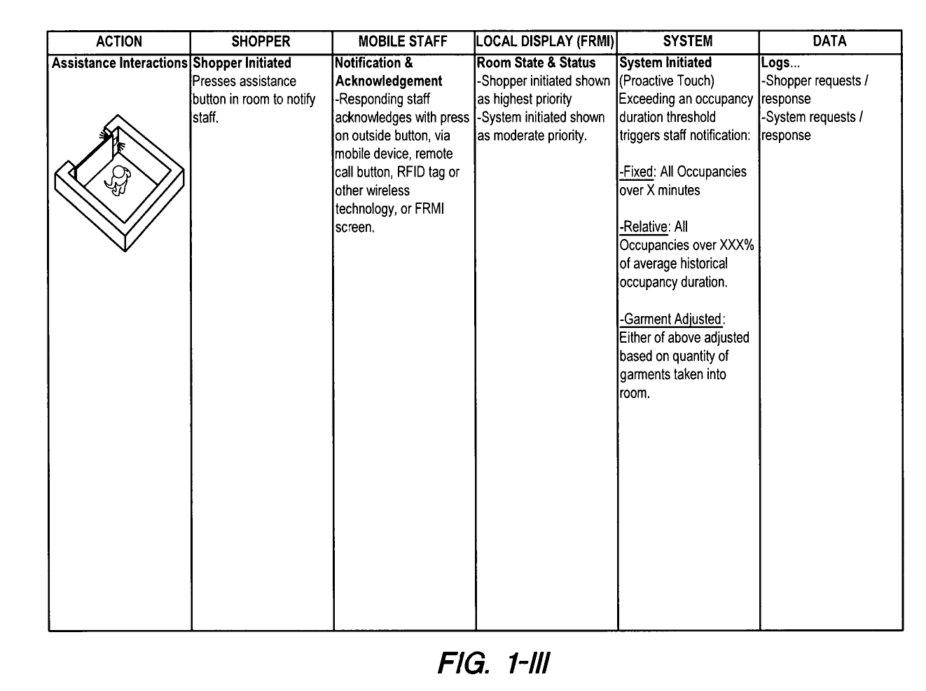

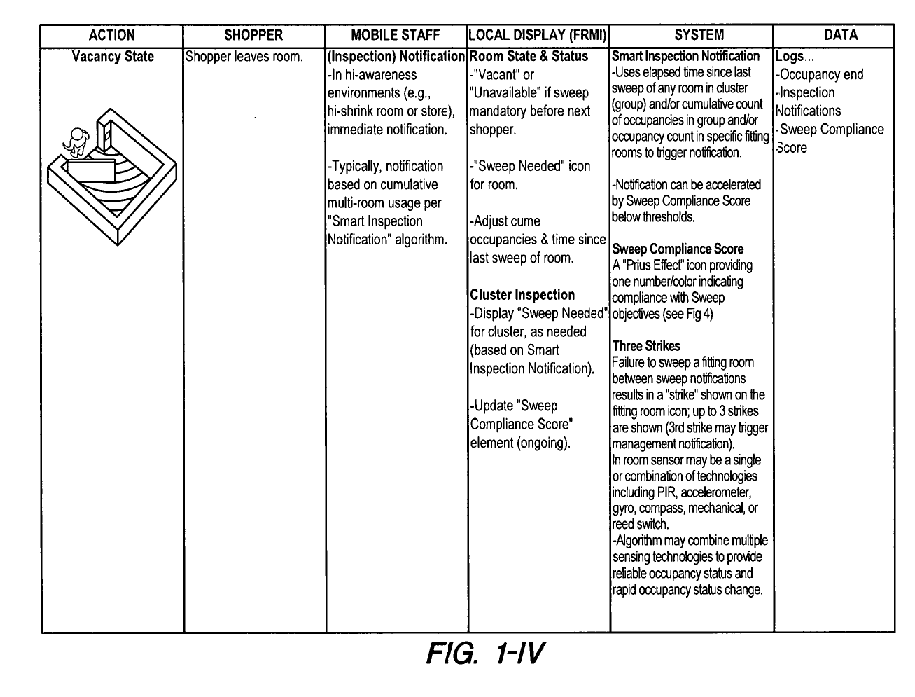

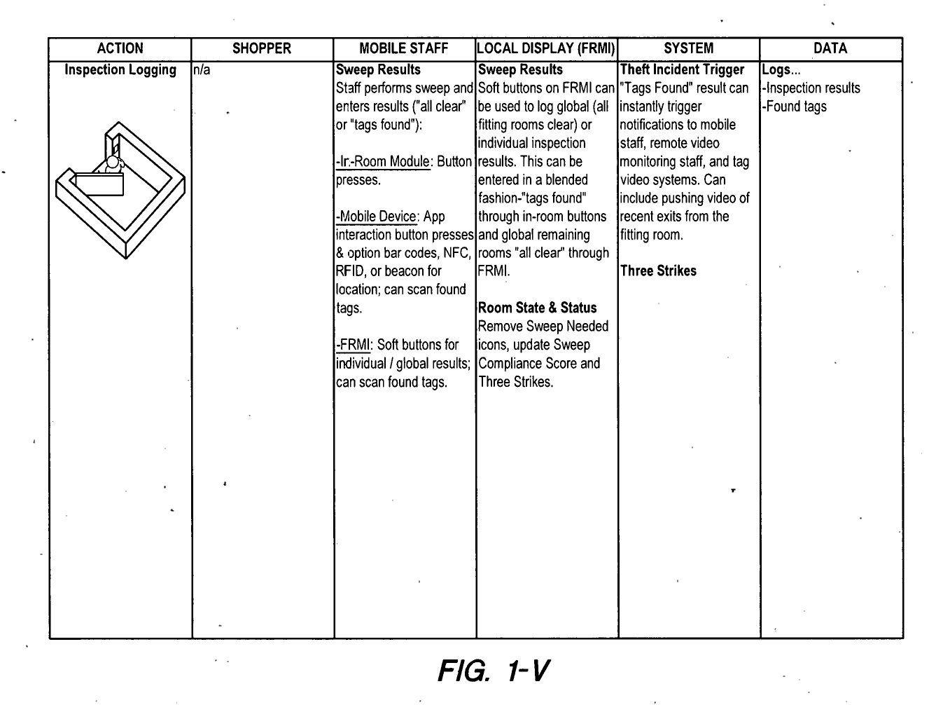

A shopper entering a fitting room is depicted in FIG. 1 panel I.

### Shopper

An outside occupied light informs the shopper of the availability status of the fitting room. The system detects a shopper entering a fitting room. If the fitting room is available but locked, the shopper presses a button on the outside sensor module to request assistance in opening the fitting room.

### Staff

Once a locked room request is initiated, store staff is notified of the request by mobile communication. The staff member presses the reset button on the system sensor module when responding to the request. While providing the shopper with fitting room access, or alternatively at any time, the store staff member may register the fitting room to exclusively receive subsequent notifications relevant to that specific fitting room. Registrations may be accomplished according to the following: a) scanning a barcode unique to a fitting room on a mobile device equipped with an appropriate software application for scanning barcodes; b) sensing a NFC tag unique to a fitting room on a mobile device equipped with an appropriate software application for sensing NFC tags; c) manual keystroke recognition or voice recognition on a mobile device equipped with an appropriate software application for accepting keystroke and voice recognition; or d) interaction with the Fitting Room Management Interface feature of the system described subsequently.

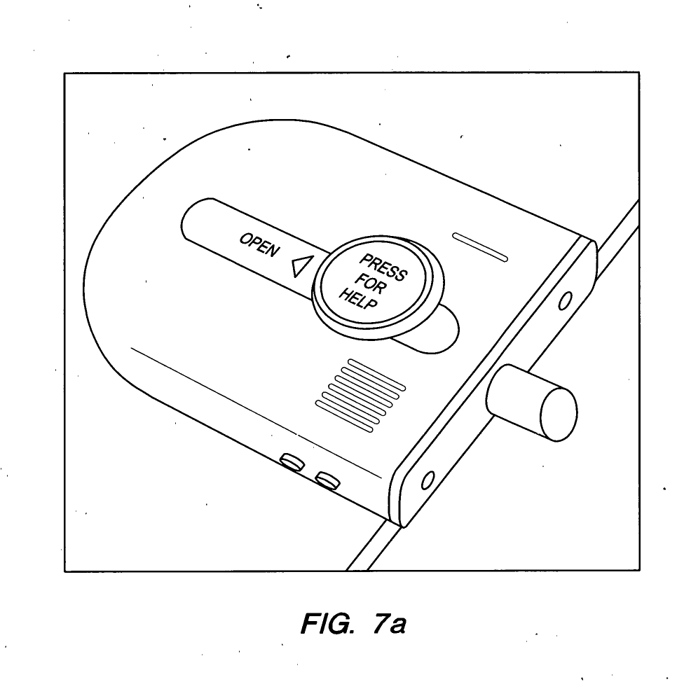

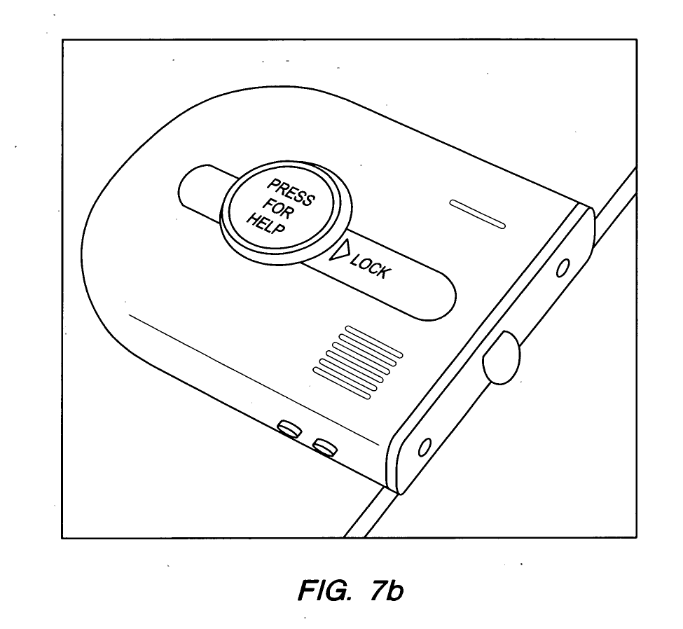

The system may further include a fitting room automated door lock (“FR-Lock”) which incorporates an electrically enabled/disabled door locking mechanism described in greater detail with regard to FIG. 7. FR-Lock utilizes a more definitive and reliable method of declaring a fitting room occupied when the door is locked from the inside.

### Local Display

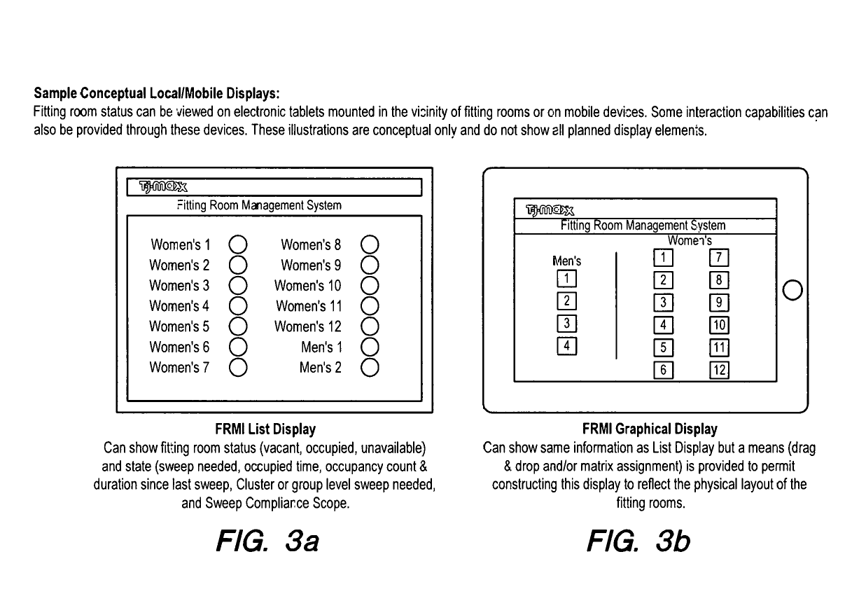

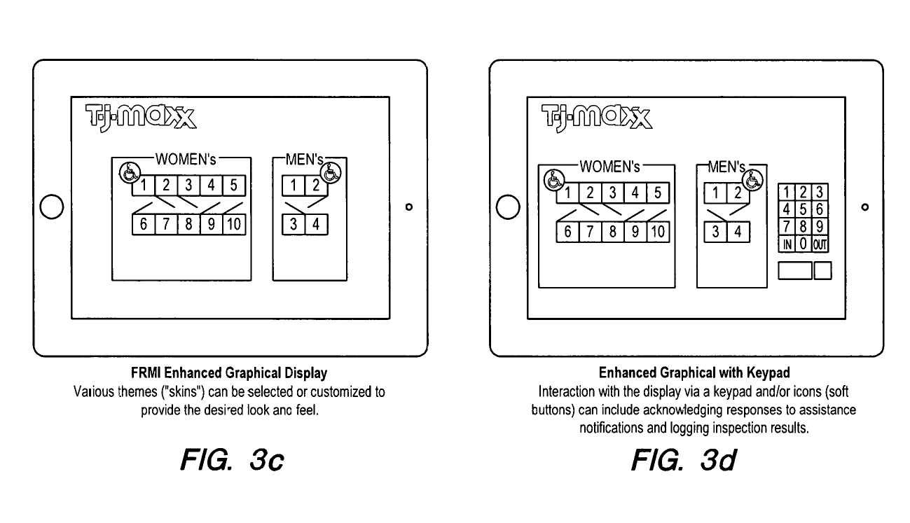

The optional Fitting Room Management Interface (“FRMI”) feature of the system provides a local display unit for store staff and will be described in greater detail with reference to FIG. 3. In a preferred embodiment, the application software unique to the FRMI may be used on any common electronic notebook which is then mounted in the immediate vicinity of the fitting area within a store. In an alternative embodiment, the application may be installed on mobile devices carried by store staff members. The local display provides information about the fitting room state and status, i.e. vacant. Other statuses include occupied and unavailable.

If the store tracks the garment count entering fitting rooms, the staff member enters the quantity of garments taken into the room at the local display. If the optional RFID feature is used by the store, the RFID reader will detect garments carried into the fitting room at the check in location, then a staff member may assign a fitting room after which the garments will be associated with the fitting room and corresponding information is displayed on the FRMI. If the optional electronic lock feature is utilized, the local display shows the locked/unlocked status of each fitting room.

### System

Using the FR-Lock feature, the system further provides for automatic setting of fitting room doors in locked/unlocked status based on business or input variables set by store management. For example, fitting room doors may be locked according to the time of day, such as based on a defined schedule such that fitting rooms may be readily available to shoppers during designated time periods during the day while access assistance requests are required during other periods of the day. In another example, fitting room doors may be locked according to store staffing and/or traffic levels. Such variables may be used independently or together to automatically place fitting rooms in locked/unlocked status using business management rules intended to balance customer service with shrink reduction needs.

Table 1 illustrates various ways in which the FR-LOCK device can be electronically set to permit or prohibit unattended entry to the fitting room. This has no relationship to the ability of a shopper inside the fitting room to lock the door.

TABLE 1
FR-LOCK State Change Chart

| Lock | Unlock | Scenario |
|---|---|---|
| X | | Normal state during open hours in hi-theft or personal touch* environment |
| | X | Normal state in low-shrink self-service environment |
| X | X | Automatically lock/unlock based on store's business rules related to known and/or |
| | | anticipated customer traffic and store employee availability using: |
| | | Time of day/day of week direct settings |
| | | Planned staffing level (from resource management system) |
| | | Actual real time staffing level (from time clock interactions) |
| | | Historical traffic levels (from POS data and/or people counting systems) |
| | | Actual real time traffic level (from people counting systems) |
| X | X | Automatically lock/unlock fitting rooms most prone to theft (based on location in the |
| | | store and/or historical “tags found” inspection results) to permit unattended access only |
| | | when high occupancy dictates the need for additional capacity |
| X | | When overall usage level allows, limit access to a recently vacated fitting room pending |
| | | inspection to ensure a tidy experience for the next shopper (such a fitting room is |
| | | considered to be in the “unavailable” state). |
| | X | Loyal customers can enter unattended by using their smart phone or interaction with a |
| | | local GUI to command an unlock; this also notifies sales personnel of the specific |
| | | customer's presence |
| | X | Customers notified of available fitting room by queue management feature may |
| | | command an unlock of an assigned fitting room using their smart phone (e.g., entering a |
| | | code, NFC, scanning a QR Code) |
| X | X | Sales associates can “start a fitting room” with clothing of interest; only the associate |
| | | and the customer (using a smart phone, fob, code entry, or other device) can then access |
| | | that room (also permits customer to leave valuables in the secure room while modeling |
| | | contemplated purchases to friends. |
| X | X | A manager or authorized employee may remotely command a lock/unlock of one, a |
| | | group, or all fitting rooms using a mobile device or GUI; used for: |
| | | Providing a customer with access to a specific fitting room |
| | | Overriding lock outs during unexpected high traffic situations |
| | | Causing a lock down when suspects enter or are observed in the store |
| X | | Advanced video management systems can command a global lockdown when facial |
| | | recognition identifies one or more known shoplifters entering the store |

*Some stores want an employee to assist a shopper into a fitting room to establish rapport.

### Data

The system may collect and log data of system functions and generate reports for management and staff review. Data logs available include, but are not limited to, fitting room access requests and corresponding staff response times, garment quantities per fitting room and garment identification if the RFID option is utilized.

### Occupied State:

The fitting room occupancy state is depicted in FIG. 1 panel II.

### Shopper

After a short delay, the presence of the shopper in the fitting room prompts the system to emit an entry sound and begin the occupied light sequence. The system includes an occupancy sensor module, such as a passive IR sensing technology (“PIR”), located inside of the fitting room door. Alternatively, the sensor may be a pressure or switch mat on the floor of the fitting room. A camera may also be mounted outside the fitting room in order to track occupancy and sense shoppers approaching the fitting room. Another sensing method is to electronically monitor the locking of the door by the shopper (as occurs with the optional lock in FIG. 7 but could also be accomplished by a switch or metal proximity detector sensing the door position and/or locking mechanism). Yet another sensing method uses a door-mounted device incorporating an accelerometer (which detects locking/unlocking activity and door movement through induced vibration patterns) combined with a gyroscope and/or magnetometer (to detect door movement and position respectively). For example, detection that the door just closed (by detecting vibration with an accelerometer, position by a magnetometer, abrupt cessation of motion by a gyroscope, or a mechanical/reed switch can then greatly reduce PIR qualification time to reliably declare an occupied state). A small “occupied” light flashes slowly on the outside and inside of the fitting room. In a preferred embodiment, the light may be different colors to distinguish between occupied and help requests. The flashing light outside the fitting room provides indication of occupancy (the color and/or flashing rate of this light could also vary to provide an approximate indication of the duration of the occupancy state) while the flashing inside the fitting room deters theft. These features in the fitting room draw the shopper's attention and deter shoplifting activity. In a preferred embodiment, the entry sound may be a tone or chime. In an alternative embodiment, the entry sound may be a voice message.

### Staff

Upon a person entering the fitting room, the PIR sensor module detects the occupancy of the fitting room. After a short qualification period, a notification, subject to business rules, is sent to staff indicating the occupancy status of the fitting room. The notification may be influenced by time of day, day of the week, staffing level, shopper traffic level or time since last notification of the same type. At this time, the system may require a confirmation action by the staff member. If the fitting room remains occupied beyond a defined time threshold, a subsequent staff notification, subject to business rules, occurs to signal the staff to proactively offer sales assistance. At this time, the system may require a confirmation action by the staff member.

### Local Display

The local display will change to identify the fitting room as occupied and an occupancy timer will start. If the optional electronic lock feature is utilized, the local display shows the locked/unlocked status of each fitting room.

### System

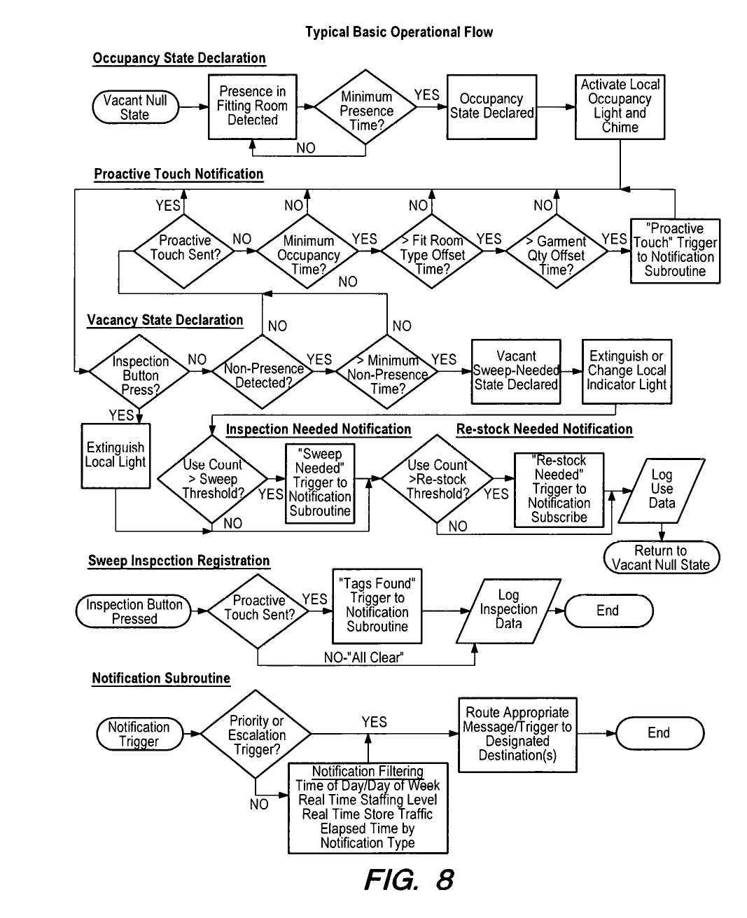

Occupancy notification, subject to business rules, occurs when the system enters the Occupied State indicating a fitting room is occupied. This state is entered when a sensor module detects enough PIR activity to be considered active and, as shown in the “Occupancy State Declaration” portion of FIG. 8, a minimum presence time has elapsed to avoid false occupancy declarations due to employees inspecting fitting rooms. Additionally, if the shopper manually locks the fitting room from inside, the room status will automatically change to occupied. Alternatively, a video camera outside the fitting room may be used to track real time analytics to declare occupancy and vacancy to the system.

The in-room or door-mounted sensor may be a single or combination of technologies including, but not limited to, PIR, accelerometer, gyro, compass, hall effect, mechanical or reed switch. Algorithms “smooth” PIR sensor detection to provide reliable occupancy status. The algorithm may combine multiple sensing technologies in order to not only provide reliable occupancy status but also rapid, accurate occupancy status change.

As illustrated by the “Notification Subroutine” section of FIG. 8, business rules related to outputting notifications for occupancy (and, as explained later, for inspection sweeps) are subject to filtering based on such factors as time of day, day of week, store staffing levels (typically provided from time clock data), store traffic (from people counting systems), and minimum elapsed time between notifications of the same type. These actions result in elimination of some prospective notifications and the delay of others so as to enable the system to appropriately adapt to actual in-store conditions and resources available to respond to the notifications.

### Data

In the occupied state, the system will track and log data associated with occupancy start times and staff notifications and corresponding staff response times.

### Shopper Assistance Interactions:

Assistance Interactions are depicted in FIG. 1 panel III.

### Shopper

By simply pressing the button on the system sensor module inside the fitting room, a person may discreetly summon assistance from staff. The system integrated feature results in the request for assistance being transmitted to staff as a notification.

### Staff

The system may also recognize and log repeat and/or escalated notifications as needed. A responding staff member may be required to perform a confirmation action in order to terminate the sequence. The system retains the data generated by the transaction, such as date, time, location and length of time to respond, for further analysis and reporting to management. The staff confirmation action may include, but is not limited to, pressing a button on a module outside the fitting room, responding via mobile device, remote call button, RFID tag, or other wireless technology are by interacting with the FRMI.

### Local Display

The local display will identify a shopper initiated request as the highest priority request. Alternatively, a system initiated request, i.e. Proactive Touch discussed below, will be identified as a moderate priority request.

### System

The system may also initiate staff requests if the optional Proactive Touch feature is activated. As illustrated in the “Proactive Touch Notification” section of FIG. 8, notifications to staff in response to occupancy times in excess of preset thresholds may occur. Thresholds may include, but are not limited to, fixed, relative, type, or garment adjusted. Fixed Minimum Occupancy Time thresholds may trigger notification of all occupancies over “X” minutes (this setting is typically set at approximately 50% to 75% of an average fitting room visit time in a high touch service environment and at approximately 125% of an average fitting room visit time when the engagement focus is on shrink reduction). Relative thresholds may trigger notification of all occupancies over XX% of average historical occupancy duration, enabling the system to dynamically adjust these settings as seasonal and other factors impact shopper behavior. Fitting room type (e.g., Men's, Women's, Children's) can also be used to more accurately determine appropriate fixed or relative threshold settings. Garment adjusted, subject to business rules, may trigger notification based on either fixed or relative thresholds when greater than a certain number of garments is taken into the fitting room.

### Data

In the Occupied Help Request State, The system will track and log data associated with shopper assistance requests and corresponding staff response times as well as system assistance requests and corresponding staff response times.

### Vacancy State and Inspection Needed Notification:

The fitting room vacancy state is depicted in FIG. 1 panel IV.

### Shopper

Once the system sensor module inside the fitting room senses that the shopper left the fitting room, a sweep needed notification may be conveyed to store staff (this need for an inspection status may also be reflected by the color and/or flash rate of the exterior light for that fitting room). The purpose of this notification is to promote prompt inspection of the now vacant fitting room to ensure the fitting room is readied for the next person and/or to ensure timely detection of stripped tags or other shrink incidence evidence.

### Staff

Upon a person exiting the fitting room and vacancy declared, the notification prompts staff to inspect the fitting room. The system allows this notification to be modified according to business logic to adjust notifications based on “X” occupancies across one or more fitting rooms across “Y” time interval through utilization of “Smart Inspection Notification” algorithms. Notifications may also be modified based on current staffing level, store traffic, or time of day. For example, during high traffic hours, inspection notifications may be triggered after more occupancies in order to keep staff focused on shoppers. Alternatively, fitting rooms known to experience higher incidence of theft may trigger inspection more aggressively than other fitting rooms. Any combination of variable inputs which are practical to a given store's needs are capable of driving the intelligent inspection notifications.

### Local Display

The local display will change to identify the fitting room as vacant or, if an inspection is mandatory before the next shopper enters the fitting room, as unavailable. The local display will also show a “sweep needed” icon for each room requiring an inspection. The local display is also capable of tracking inspection of fitting room clusters, based on the Smart Inspection Notification feature. Following inspection, the display will provide an updated sweep compliance score for each fitting room and/or each cluster of fitting rooms.

### System

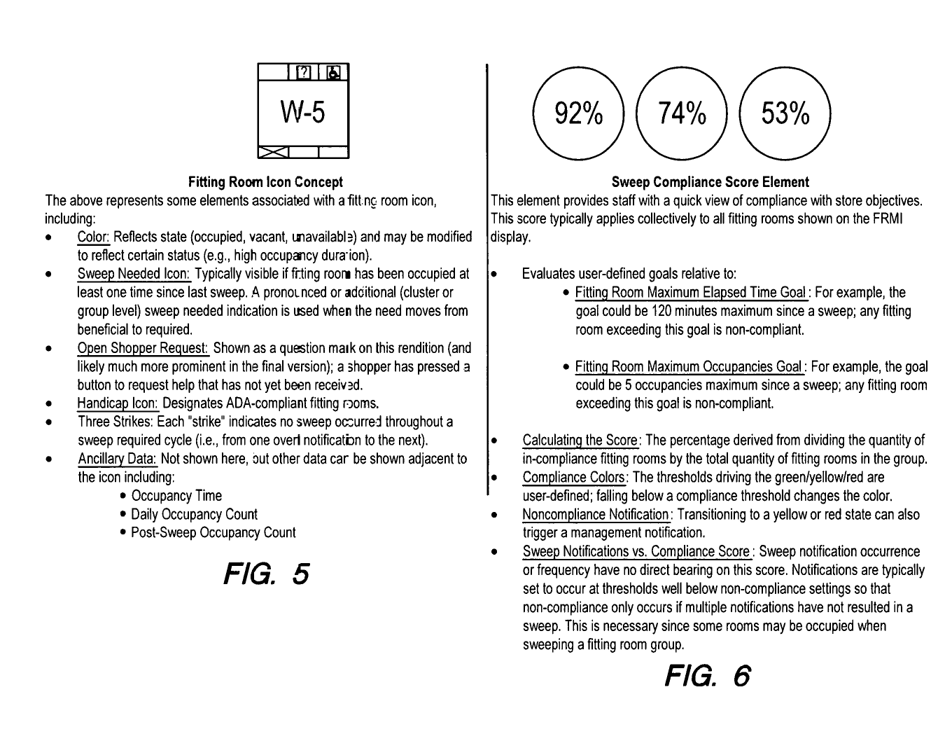

Smart Inspection Notification tracks elapsed time since the last sweep of any room in a cluster of fitting rooms and/or, as shown in the “Inspection Needed Notification” section of FIG. 8, the cumulative count of occupancies in a group and/or the occupancy count in specific fitting rooms to determine when to send inspection notifications to staff. Notification may be accelerated by the sweep compliance score of FIG. 6 dropping below a set threshold. Failure to sweep a fitting room between sweep notifications may result in a “strike” shown on the fitting room icon of FIG. 5, which can display up to three strikes. The logging of a third strike may trigger a notification to management of non-compliance.

### Data

In the vacancy state, the system will track and log data associated with occupancy end, inspection notifications and sweep compliance scores.

### Inspection Logging:

The fitting room inspection logging is depicted in FIG. 1 panel V.

### Staff

A staff member responding to a vacancy or sweep required notification (or at any time a sweep needed condition exists for the fitting room—which typically is after at least one occupancy, regardless of notifications) may log inspection results by simply pressing a button on the system sensor module inside the fitting room to indicate the inspection results of “all clear” or “tags found.” Other methods may include scanning one or more bar codes or Near Field Communication (NFC) tags signifying inspection findings or an application on a smart mobile device or tablet. In the later instance, the logging of “tags found” may instantly tag video surveillance to help identify potential perpetrators. Unlike paper inspection logs, electronic logging provides chain wide assurance of compliance. The SKU bar codes on found tags can also be scanned to easily add this detail to the incident data.

### Local Display

Soft buttons on the FRMI or a similar device can be used to log global (all fitting rooms clear) or individual inspection results. Inspection results may be entered in a blended fashion, i.e. through both the in-room module and through the FRMI. Once inspection results are entered, the local display will clear sweep needed icons, update the sweep compliance score and the three strikes indicators.

### System

As illustrated in the “Sweep Inspection Registration” section of FIG. 8, once inspection results are logged, the status of the fitting room is updated by the system. An indication of “all clear” results in the fitting room being labeled available or unoccupied and ready for the next customer. In the alternative, an indication of anything other than “all clear” may trigger additional notifications. For example, if evidence of theft is discovered and an indication of “tags found” is logged, store management or Loss Prevention personnel may receive a notification indicating the occurrence of a possible theft event. Simultaneously with the notification being sent, video surveillance systems may be tagged for immediate or later review because the perpetrator may be visible on video immediately prior to the time of the prompt discovery of evidence. The notifications, tagging of video surveillance, and/or images of possible suspects exiting the fitting room area may be transmitted to management and/or Loss Prevention personnel via mobile device applications.

The system may also provide an inspection noncompliance notification to one or more staff members, usually management, when an expected inspection logging fails to meet minimum expectations. For example, the system may provide notifications based on the number of inspections or the total length of the elapsed time between the vacancy notification and the logging of inspection results. The Smart Inspection Notification uses elapsed time since the last sweep of any room in a cluster of fitting rooms and/or cumulative count of occupancies in the group of fitting rooms and/or occupancy count in specific fitting rooms to trigger a sweep notification. Sweep notification may be accelerated if the sweep compliance score falls below a set threshold. Additionally, failure to sweep a fitting room between sweep notifications results in a “strike” shown on the local display, with up to three strikes shown. The display of a third strike may trigger a notification to management of sweep noncompliance.

### Data

In the inspection logging state, the system will track and log data associated with inspection results and found tags.

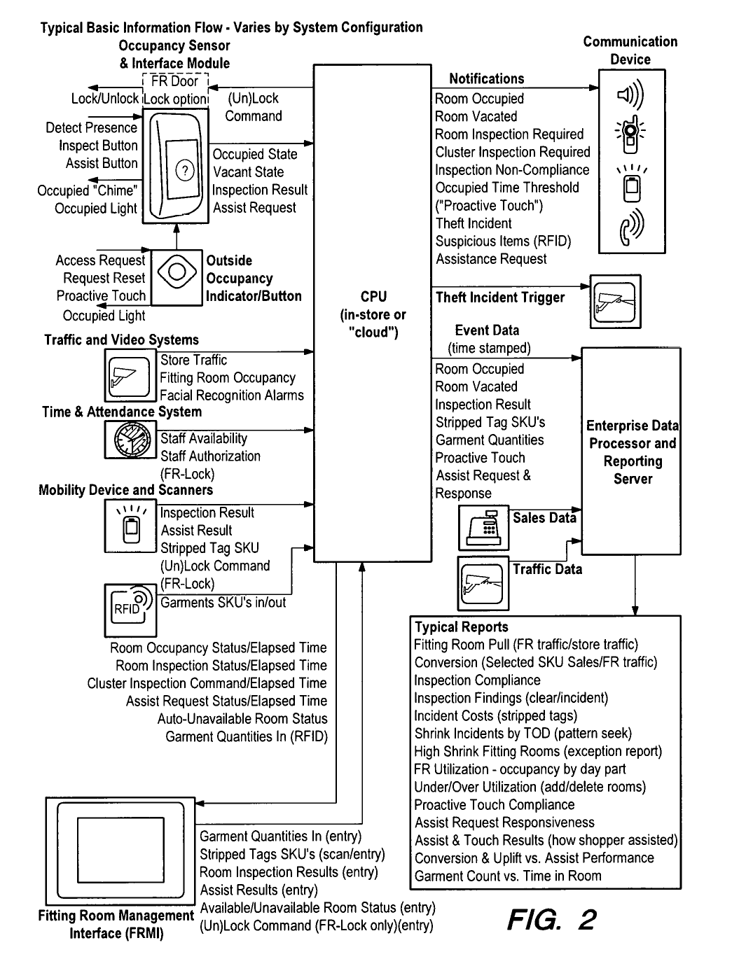

With reference to FIG. 2, depicted is the typical basic information flow in one embodiment of the system. A critical piece of the present invention is the central processing unit (“CPU”) which may be present in the form of proprietary in-store hardware or “cloud” processing using standard computer hardware. All information flowing through the system is processed by and/or stored on the CPU and routed to the appropriate location and/or device.

With reference to FIG. 3, FRMI expands the functionality of the system by providing visual indictors of fitting room status (vacant, occupied, unavailable) and state (sweep needed), occupied time, occupancy count and duration since last sweep, cluster or group level sweep and sweep compliance score. For example, using status data provided by the system occupancy sensor module, the FRMI uses icons and colors to display the current status of each fitting room whereby allowing the staff member to quickly determine which fitting room is available to the next customer. In an alternative embodiment, using simple color coding such as “green” for unoccupied and “red” for occupied, a shopper can quickly determine without assistance which fitting rooms are available in the case of the unattended fitting area. FIG. 3a provides an example of a FRMI list display. FIG. 3b provides an example of a FRMI graphical display. FIG. 3c provides an example of a FRMI enhanced graphical display. FIG. 3d provides an example of a FRMI enhanced graphical display with keypad allowing for interaction with the display in order to respond to assistance notifications and log inspection results. FRMI is also customizable to permit construction of the display to reflect the physical layout of the fitting rooms.

FRMI is also capable of displaying text, clock-type charts or other visual indicators to show how long each fitting room has been occupied. In the event that fitting rooms are occupied for extensive periods of time, real-time automatic data evaluations can provide color or graphic indicators to alert staff members. Thresholds for such indicators can be based on variables programmed into the system and may be further influenced by the quantity of garments taken into the room, etc. Adaptive algorithms may automatically establish thresholds for excessive occupancy based on past occupancy data collected and stored by the system. When occupancy length approaches an established threshold, a notification may be transmitted to staff to alert them to any suspicious activity or to encourage asking if the customer desires assistance.

FRMI may also be configured to display assistance requests by shoppers in the fitting rooms and occupancy threshold trigger notifications requiring confirmation actions by staff members. The elapsed time since the assistance request may also be recorded. Assistance request notifications may trigger a local FRMI audio alarm to sound prompting staff to acknowledge the request and perform a confirmation action to clear the request. It is further contemplated that responses and confirmation actions may be associated with specific staff members when a login feature is used.

FRMI may be used by staff and/or management to track garments entering the fitting rooms. A staff member selects a fitting room and enters the quantity of garments a customer takes into that specific fitting room. Upon the customer exiting the fitting room, the staff member verifies the quantity of garments being removed equals the number of garments that entered and clears the fitting room for use by the next person. It is further contemplated that a bar code or RFID method may be used to track garments taken into fitting rooms. Such bar code or RFID data may be processed by the system of the present invention, however unlike data manually entered into the system, these methods can cause the display of specific SKU, size and item description information, thereby allowing FRMI to display the data visually and provide a means for identification of actual merchandise using an existing SKU database. It is still further contemplated that the system may trigger a “suspicious item” notification when non-clothing items or excessive quantities of items are detected in a given fitting room.

FRMI may further be used to track inspection logging results. Typically a staff member confirms inspection findings through entering the results on the system sensor module in the fitting room, as described above. Alternatively, inspection loggings may be entered using FRMI or the mobile device application, which is capable of capturing data regarding which fitting room is being inspected through barcodes, NFC tags, micro geo location or manual entry. The displayed inspection status, which is dependent on business rules discussed previously, may use colored icons and/or text to provide relevant information associated with each fitting room. Such relevant information includes, but is not limited to, elapsed time since vacancy was declared and/or since an inspection notification issued, quantity of occupancies since the last logged inspection, and quantity of shrink incidents as calculated by shrink incident inspection entries logged. FRMI is further capable of tracking cluster inspection status when business rules evaluate fitting room use across an entire cluster of fitting rooms and only issue inspection notifications based on overall use and other factors (described in greater detail regarding FIG. 6).

FRMI may be used to collect and track shrink evidence recovered from fitting rooms upon inspection such as tags with merchandise SKU's, brand identification or item description labels. Relevant information may be entered using a scanner and/or camera on the FRMI/mobile device or through keypad entry to identify and store in the system the types of merchandise stolen. As a result, shrink may be further identified according to specific items or monetary loss per fitting room or even on a daily basis collectively across all fitting rooms.

FRMI may also be used by staff to designate fitting rooms unavailable for use. An algorithm continuously assesses the occupancy of each fitting room and collects traffic levels to automatically place high-shrink and/or uninspected fitting rooms into the unavailable category when not required to accommodate shoppers. The automatic unavailable feature reduces the opportunity for theft and increases staff productivity since fewer fitting rooms are in use and requiring inspection.

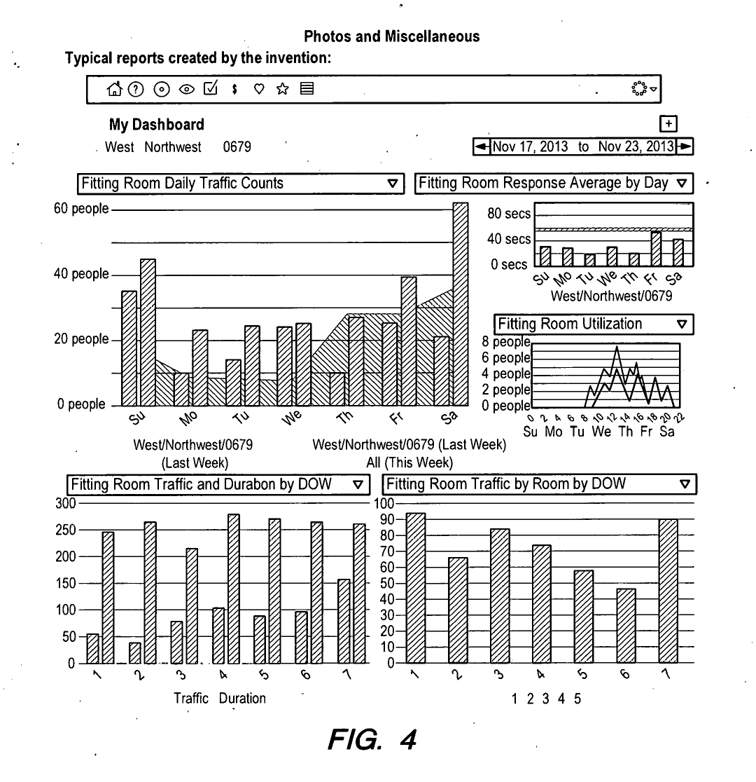

With reference to FIG. 4, depicted are sample reports created from data collected and/or tracked by the system. The system of the present invention is capable of analyzing occupancy and inspection data collected and stored in the system which may then be displayed visually as unique presentations. Analytics may include, but are not limited to, conversion rates relative to fitting room occupancy traffic, fitting room use rates relative to overall store traffic, which fitting rooms suffer the highest theft incidents and when, and analysis of the best use of floor space such as sales space value v. use of space as fitting rooms.

With reference to FIG. 5, depicted is the Fitting Room Icon Concept. The fitting room icons on the local display or FRMI provide store staff with a quick and easy to understand summary of activity at each fitting room. Elements associated with the fitting room icon include, but are not limited to, color, sweep icons, request icons, handicap icons, three strike icons and ancillary data. Color may be used to reflect the status of the fitting room and may be modified to reflect certain statuses (e.g. high occupancy duration). The sweep needed icon is typically visible if a fitting room has been occupied at least once since the last sweep. A pronounced or additional sweep needed indication may be displayed when the need moves from beneficial to required. The open shopper request icon, shown as a question mark, indicates to staff that a shopper has pressed a button for assistance that has not yet been answered. A handicap icon designates ADA-compliant fitting rooms. Three strike icons may be displayed; each strike indicating no sweep occurred throughout a sweep required cycle. Additional data may be shown adjacent to the icon including, but not limited to, occupancy time, daily occupancy count, and post-sweep occupancy count.

With reference to FIG. 6, depicted is the Sweep Compliance Score Element. This element provides staff with a quick view of compliance with store objectives. The score typically applies collectively to all fitting rooms shown on the FRMI display. This element evaluates user defined goals relative to fitting room inspection. Color may be utilized to quickly indicate compliance with thresholds driving the green/yellow/red color being user defined, wherein crossing a defined compliance threshold changes the icon color. Additionally, transitioning from a yellow to red icon may trigger a non-compliance notification to management.

With reference to FIG. 7, depicted is the fitting room e-lock for the system. FIG. 7a illustrates the FR-lock in the locked position while FIG. 7b illustrates the FR-lock in the alternate unlocked position. Though illustrated with a mechanical latching mechanism, an alternative embodiment of the FR-Lock can incorporate a low-power magnetic locking mechanism. FR-Lock may also provide a PIR sensor to detect the presence of a person at and/or in a fitting room. FR-Lock may further provide audio and light indicators, or any suitable mechanical indicator, outside a fitting room to indicate occupancy and/or notify a waiting shopper that the room has been unlocked when staff has done so by way of a remote unlocking feature. Incorporation of the FR-Lock feature in the system provides keyless entry by authorized staff using mobile smart devices or by logging into the Fitting Room Management Interface. Authorized staff may be any staff member on duty, cleared for performing this operation and properly logged into a suitable communication device. An FR-Lock application on the device enables the staff member to send an “unlock” command to the FR-Lock module located at the fitting room to enable a shopper to access a now unlocked fitting room.

The FR-Lock feature further provides for automatic setting of fitting room doors in locked/unlocked status based on business or input variables set by store management. For example, fitting room doors may be locked according to the time of day, such as based on a defined schedule such that fitting rooms may be readily available to shoppers during designated time periods during the day while access assistance requests are required during other periods of the day. In another example, fitting room doors may be locked according to store staffing and/or traffic levels. Such variables may be used independently or together to automatically place fitting rooms in locked/unlocked status using business management rules intended to balance customer service with shrink reduction needs. Fitting rooms known to represent the highest shrink risk, as determined by manual system configuration or through an adaptive algorithm which monitors inspection findings, may remain locked for all except peak traffic times and/or when all other fitting rooms are occupied. In another example, authorized staff may command all fitting rooms in a cluster to be placed in locked/unlocked status through use of the mobile application or the Fitting Room Management Interface. In yet another example, a Loyalty Unlock feature may be used by loyal shoppers to unlock the fitting room door using an application module downloaded on the shopper's personal mobile device. In an additional example, shoppers or staff may use RFID or bar codes to scan clothing to be taken into the fitting room and, upon doing so, the door would unlock. In still another example, advanced video systems may be incorporated to use facial recognition to detect known shoplifters, the presence of which may cause an immediate lockdown of all fitting rooms causing shoppers (and the suspected shoplifter) to require store staff assistance to access fitting rooms.

With reference to FIG. 8, much of which has been discussed above, the “Re-stock Needed Notification” section illustrates how cumulative fitting room occupancy data estimates when a sufficient quantity of clothing left unsold by shoppers has accumulated in the fitting room area and should be re-stocked. The responding store employee triggers a confirmation action to avoid escalations and to reset the accumulation counter.

Real World Retail Problems and The System Solutions:

Problem 1: Theft of retail merchandise using the privacy of fitting rooms to remove alarm tags and conceal items is an enormous problem. A major sporting goods store was experiencing an average of four theft incidents (as evidenced by stripped tags abandoned in fitting rooms) daily.

Solution: Immediately after installation of the system, the incidence of this type of theft was reduced from four per day to approximately three per week. Store management attributed this remarkable reduction to the local occupancy light and chime, which makes the thief nervous, and the Proactive Touch which promoted engagement of the customer by store staff.

Problem 2: As part of a program to expand the size of fitting rooms, a major apparel retailer reduced the quantity of rooms and allowed shoppers to bring more garments in than previously. This resulted in excessive wait times during busy shopping hours which significantly reduced sales due to abandonments.

Solution: Occupancy data analysis provided by the system enables retailers to assess fitting room usage levels prior to taking such measures. Reports identify when and how often all rooms are occupied; this data is used to determine if floor space is more profitably used for fitting rooms or sales space and even if the garment limit should be lowered during certain day-parts.

Problem 3: Marks & Spencer, a major UK department store chain, closed their fitting rooms during the 2013 peak shopping season to avoid customers waiting excessively, with disastrous customer backlash. Many customers simply decided to make their clothing purchases elsewhere.

Solution: The system provides a mechanism by which shoppers may form a “virtual queue” in which they will be notified through their smart phone when a fitting room has been reserved for their use. This enables the customer to remain occupied and continue shopping (increasing the sales ticket) while waiting for a fitting room. The invention's smart electronic lock empowers the customer to exclusively access the reserved fitting room after notification.

Problem 4: A major apparel retail chain suffered sales losses as unsold merchandise at fitting rooms (often the most popular items) were not re-stocked for customer access in a timely fashion.

Solution: The system uses cumulative fitting room occupancies to estimate and notify when re-stocking should occur to provide a balance between productivity and merchandise access. Responding associates take a confirmation action (such as pressing a local button) when the clothing is re-stocked.

One embodiment of the system provides a fitting room occupancy monitoring and management system. In a preferred embodiment, the system is capable of monitoring and managing the status of a plurality of fitting rooms in one or more fitting room areas within a retail setting.

In another embodiment, the system provides store staff members with occupancy notification through staff communication devices according to algorithms capable of balancing awareness with nuisance levels of notifications. In a preferred embodiment, notifications are filtered by programmable influences, such as amount of fitting room usage over recent time, current traffic and/or in-store customer count, time of day or incidents of theft in order to provide more notifications for high-risk fitting rooms.

In still another embodiment, the system provides in-room occupancy sound in the form of a chime or voice message and a small flashing light.

In yet another embodiment, the system provides intelligent inspection notifications. Business logic functions may tabulate and/or filter vacancy detection to provide inspection notifications based on a retailer's selected strategy. For example, an inspection notification may be sent to a staff member communication device after “X” occupancies, after “X” occupancies across “Y” time interval, or notification may instruct inspection of an entire cluster of fitting rooms when certain usage thresholds across the cluster and/or certain fitting rooms in the cluster is exceeded.

In still another embodiment, the system provides a means to electronically log inspection results for each fitting room. Alternative embodiments may include using a mobile device to read a barcode or NFC tag along with manual results entry through a mobile device. It is further contemplated that a centralized interface may be used to confirm inspections and results for a cluster of fitting rooms.

In a further embodiment, the system provides a commissioned salesperson with the ability to register a fitting room. Once registered, a subsequent shopper assistance request is routed exclusively to the registered salesperson's communication device. Registration can be performed by barcode or similar reader, NFC tag detection, through a mobile device application, a management screen application, or a unique code fob reader.

In a further still embodiment, the system provides a means of incorporating a physical door locking mechanism at each fitting room with the system of the present invention. Specifically, the FR-Lock feature may recognize the using of the actual locking of the door from the inside of each fitting room as an occupancy sensing method. Alternatively, unique methods of automatic locking of fitting room doors may occur based on programmable factors such as store traffic, facial recognition of a suspect entering the store, staffing levels or fitting rooms experiencing high theft levels. In a preferred embodiment, keyless unlocking of fitting rooms by authorized staff using mobile devices may be accomplished.

In another embodiment, the system may provide a Virtual Queuing Option enabling shoppers to continue to shop (building tickets) instead of getting frustrated by waiting in a physical line for an available fitting room. A shopper wishing to use a fitting room may register with the system for either the next available fitting room or include a desired time offset from registration. Once a fitting room is available, the shopper is notified that their fitting room, as indicated by room number, is reserved for the next “X” minutes. Notification may be via pager, visual display screens, and shopper's cell phone or by store PA system. FRMI display may show the fitting room as unavailable and reserved by a unique status color for the room icon, by listing the corresponding pager number or last four digits of the shopper's phone number along with a countdown to the expiration of the reservation. For unattended fitting room areas, a means for the shopper to exclusively unlock the reserved fitting room may also be incorporated such as using their own mobile device and the store's mobile application or an SMS text messaging command or by entering a code through the FRMI display or a similar device located in the fitting room area,

In yet another embodiment of the system, fitting room transaction data may be retained, including but not limited to, date and time of occupancies and vacancies, confirmation actions and corresponding response times to compulsory response notifications, and inspection findings.

In still another embodiment of The system, system analytics include, but are not limited to, fitting room usage levels, frequency and duration of “all occupied” fitting room cluster status, identification of low-usage fitting rooms, compliance with fitting room inspection objectives, rate of theft incidences by fitting room, level of theft incidences per occurrence and averaged, fitting room usage rate based on store and/or department traffic v. fitting room occupancies, conversion rates based on fitting room occupancies and sales of specified SKU categories, and conversion and sales increase relative to assistance response and sales assistance performance.

It is further contemplated that The system may be adapted for use with any usage-based triggering task activities, including but not limited to, gym locker room inspections after “X” occupancies, restroom inspection/cleaning/restocking supplies after “X” uses, cleaning of food court tables or similar locations based on usage level, emptying food court trash bins or other open areas based on usage, e.g. trash lid openings, tidying a clothing or other merchandise area based on shopper activity, refreshing salad bar and similar supermarket areas based on actual visits or purchases, and cleaning and restocking condiment and buttering station counters at theaters based on customer traffic or purchases.

It will be appreciated that details of the foregoing embodiments, given for purposes of illustration, are not to be construed as limiting the scope of the invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is further defined in the converted utility application and appended claims. Further, it is recognized that many embodiments may be conceived that do not achieve all the advantages of some embodiments, particularly preferred embodiments, yet the absence of a particular advantage shall not be construed to necessarily mean that such an embodiment is outside the scope of the present invention.

What is claimed is:

1. A system for, quantifying a rate of product conversion based on at least one metric associated with a fitting room, the system comprising:
at least one occupancy sensor to detect the present or absence of either an individual or a product;
at least one processor, wherein the processor categorizes data associated with the individual use of the fitting room; and
a dataset collected based on preset parameters programmed according to a desired set of business rules,
wherein the at least one processor comprises a conversion software, wherein the conversion software uses the dataset collected and applies at least one value on at least one weighted variable to quantify the rate of product conversion.

2. The system of claim 1 wherein the at least one weighted variable is selected from the group consisting of elapsed occupancy time, number of occupancies, sweep inspection compliance, re-stock compliance, time of day, day of the week, real time staffing level, number of theft incidences, number of access requests, garment quantities per fitting room, product purchases and/or real time store traffic.

3. A security system for monitoring and preventing theft activities, comprising: an indicator element, wherein the indicator element provides an occupancy status of a fitting room, an occupancy sensor to detect the presence or absence of an individual, wherein the occupancy sensor is connected to a processor comprising security software, wherein the processor captures data associated with the individual in relation to the fitting room.

4. The security system of claim 3 wherein the indicator element is triggered by locking of the fitting room door from the inside.

5. The security system of claim 4 wherein the indicator element provides an in-room occupancy sound and/or message in conjunction with a flashing light.

6. The security system of claim 3 wherein the occupancy sensor is triggered by an individual entering or exiting the fitting room.

7. The security system of claim 3 wherein detection of an individual by the occupancy sensor results in a notification to staff of fitting room occupancy.

8. The security system of claim 3 wherein the processor comprises a conversion software, wherein the conversion software uses the data collected and applies at least one value on at least one weighted variable to quantify the rate of product theft.

9. The security system of claim 8 wherein the at least one weighted variable is selected from the group consisting of elapsed occupancy time, number of occupancies, sweep inspection compliance, re-stock compliance, time of day, day of the week, real time staffing level, number of theft incidences, number of access requests, garment quantities per fitting room, product purchases and/or real time store traffic.

10. A security method for monitoring fitting room occupancy, comprising:
(a) providing an occupancy sensor for detecting an occupancy event of a fitting room;
(b) providing an indicator element coupled with the occupancy sensor for displaying the occupancy status of a fitting room;
(c) connecting the occupancy sensor to a processor, wherein the processor further provides communications to staff regarding activity in the fitting room; and
(d) providing a locking feature to be engaged based on a calculation from the processor.

11. A security system for engaging or disabling a locking feature embedded in a fitting room based on a local cue, wherein the local cue is either preset or is measured in real time based on at least one variable.,

12. The security system of claim 11 wherein the at least one variable is selected from the group consisting of elapsed occupancy time, number of occupancies, sweep inspection compliance, re-stock compliance, time of day, day of the week, real time staffing level, number of theft incidences, number of access requests, garment quantities per fitting room, product purchases and/or real time store traffic.

13. A system for initiating staff and customer interaction at a fitting room, comprising:
(a) at least one sensor module inside the fitting room used to transmit a communication to at least one staff member, wherein the communication is transmitted to at least one receiver, wherein the as least one receiver records at least one data point selected from the group consisting of date, time, location and length of time for response; and
(b) a local display within a fitting room.
